(19) United States
(12) Patent Application Publication
(10) Pub. No.: US 2015/0307105 A1
(43) Pub. Date: Oct. 29, 2015

(54) Personalized Driver Assistance

(71) Applicant: Bayerische Motoren Werke Aktiengesellschaft, Muenchen (DE)

(72) Inventor: Christian HUBER, Freising (DE)

(21) Appl. No.: 14/696,950

(22) Filed: Apr. 27, 2015

(30) Foreign Application Priority Data
Apr. 25, 2014 (DE) 10 2014 207 807.5

(51) Int. Cl. B60W 40/08

(52) U.S. Cl. CPC B60W 40/08; B60W 2040/0827

(57) ABSTRACT

A method and system are provided for personalized assistance for a driver of a motor vehicle. At least one first measurement value characterizing a physical and/or psychological state of the driver is detected by sensors in a driver state detection. The first measurement value, or a combination of a plurality of such first measurement values, is compared with an assigned predetermined target state or target state range. A driver intervention in which a predetermined signal is generated or altered takes place if, in the comparison, there is determined to be a deviation of the first measurement value or the combination of first measurement values from the assigned predetermined target state or target state range. In advance, a driver-dependent designation of at least one sensory channel of the driver to be addressed in the driver intervention has been made, and the signal is predetermined in accordance with the determined deviation. The signal is furthermore predetermined so as to be suitable for addressing the at least one designated sensory channel.

### CROSS REFERENCE TO RELATED APPLICATION

This application claims priority under 35 U.S.C. §119 from German Patent Application No. 10 2014 207 807.5, filed Apr. 25, 2014, the entire disclosure of which is herein expressly incorporated by reference.

### BACKGROUND AND SUMMARY OF THE INVENTION

The present invention relates to a method and system for personalized assistance for a driver of a vehicle, and in particular a motor vehicle.

Systems for driver state detection in motor vehicles, which form the basis for a variety of driver assistance systems, are known in the prior art. In such systems, the driver's current physical and/or physiological state is detected, and the assistance systems adapt the manner in which they assist the driver to the detected state, at least to a certain extent. In known systems, the driver state can be detected in particular by means of cameras aimed on the driver in the interior of the vehicle, and by means of monitoring of switches operated by the driver in order to control a navigation system, the car radio, or the like. As one example, a driver state detection by means of monitoring of the driver's closing of the eyelids, which is detected through cameras and assessed by an on-board computer, is a common method of detecting different stages of driver fatigue.

Another known technique is for sensors in the vehicle to constantly acquire information about the driving behavior, such as about the dynamics of steering movements or the extent and frequency of braking and accelerating operations. Such sensor data can then be compared to a driver profile, which has been determined at the beginning of the ride. From deviations between the sensor data and the driving profile, it is possible to deduce the driver's fatigue stage.

If the driver state detection of such known systems ascertains that there is a lack of attentiveness or an elevated level of fatigue and thus an elevated risk of an accident, then a driver state intervention takes place. Then, on one hand, different assistance systems may be shifted into some form of alert, or activated or deactivated, while on the other hand, the system may warn the driver via a signal, which may in particular be audible, visual, or haptic.

Regarding this matter, the publication of German patent application DE 103 22 458 A1 describes a method of intervening in the workload on a driver during a ride in a motor vehicle, in which a workload value is determined from sensor-acquired physiological data about the driver, and various signals are generated, altered, or suppressed on the basis thereof.

The known systems for detecting the driver state and for intervening with the driver are alike in that they analyze and intervene with or assist the driver during the ride and, when doing so, refer to measures of intervention or assistance that are designated in a system-specific manner.

In view whereof, the present invention addresses the problem of further improving the assistance for a driver of a vehicle.

The problem is solved according to the invention, wherein, in a first aspect of the invention, a method is provided for personalized assistance for a driver of a vehicle, in particular a motor vehicle. The method entails a driver state detection by way of sensor-based acquisition of at least one first measurement value characterizing a physical and/or psychological state of the driver. The at least one measurement value acquired in the driver state detection, or a combination of a plurality of such first measurement values is compared with an assigned predetermined target state or target state range. If the comparison establishes that the first measurement value or the combination of first measurement values deviates from the assigned predetermined target state or target state range, then there is a driver intervention in which a predetermined signal is generated or altered. To that end, at least one sensory channel of the driver needing to be addressed in the driver intervention is designated in a driver-dependent manner. The signal is predetermined in accordance with the established deviation. In addition, the signal is predetermined so as to be suitable for addressing the at least one designated sensory channel.

A “sensor-based acquisition of at least one first measurement value characterizing a physical and/or psychological state of the driver” in the sense of the present invention is intended to refer to a measurement of a parameter of the human body or movements thereof, in particular the pulse rate, skin moisture, eye movement, pupil size, blood pressure, respiratory rate or respiratory sounds, weight of the body, or the motion profile thereof, by use of at least one sensor. The parameter may also here be determined and, in particular, calculated from the parameters of a plurality of individual measurements.

A “target state or target state range” assigned to a first measurement value or a combination of a plurality of first measurement values in the sense of the present invention is intended to refer to a non-empty set of one or more values, which is associated with the parameter needing to be measured or the combination needing to be determined of parameters needing to be measured, and which constitutes a target value or target value range for the first measurement value or the combination of first measurement values. The target value or target value range is preferably selected so as to correspond to a physical or psychological target state of the driver, which in particular enables adequate attentiveness and relaxation for safe driving.

Finally, a “signal” in the sense of the present invention is intended to refer to a physical action generated from a technical object, the action directly addressing at least one human sense, in particular the sense of hearing, the sense of sight, the sense of smell, or the sense of taste, or the kinesthetic sense, the sense of temperature, or the sense of balance. Here, the term “sense” refers to the physiological perception of the environment, with the sense organs, and each sense corresponds to a “sensory channel.”

By way of the invention, the driver intervention is unlike previously known systems in not being independent of individual persons or made solely on the basis of system-specific defaults or settings. Instead, the signal that serves for the driver intervention is selected depending on the person of the driver and in accordance with his physical or psychological state, so as to address a predetermined sensory channel of the driver. The sensory channel is predetermined therein so as to be suitable for intervening with this driver particularly effectively in a desired sense, in particular in order to reduce the risk of an accident. In this manner, it is possible to give consideration to, for example, handicaps and in particular visual impairment or auditory impairment of the driver, or psychological characteristics, so that the signal activates a prioritized sensory channel that is preferred for this driver through the signal, first or instead of less-receptive sensory channels, thus achieving a more effective driver intervention.

Preferred embodiments and developments of the invention, and in particular of the method according to the invention, shall be described below, each of which can be discretionarily combined with others and with the other aspects of the invention, except where this is explicitly excluded.

According to a preferred embodiment, the driver state detection comprises a sensor-based acquisition of at least one first measurement value characterizing a physical and/or psychological state of the driver, while the driver is located outside the vehicle. In this manner, the driver state detection can already begin before the ride, and can also cover a longer period of time before the ride. In particular, then, the driver state detection can last over a period of 24 hours (24hr-tracking) or even longer, which can enable more accurate conclusions about the driver's physical and psychological state than is possible only during the ride. Thus, for example, it is even possible to detect the driver's state during sleep at night, from which conclusions can be drawn regarding the driver's state of fatigue or rest, or his current fitness or mental load. The latter can be carried out in particular by detecting the driver's movements during sleep through movement or acceleration sensors, or a sound sensor.

According to a further preferred embodiment, the first measurement values are acquired by sensor, by means of one or more of the following measuring devices: a seat occupancy sensor and, in particular, a seat occupancy mat, smart materials and, in particular, smart textiles comprising a sensor, a smart watch, a steering wheel sensor, a camera, smart glasses and, in particular, those comprising an eye-tracking function, and a communication terminal comprising a sensor.

The sensor can be, in particular, a pulse measurement sensor, a blood pressure sensor, a movement or acceleration sensor, a moisture sensor, a temperature sensor, or a camera. With the exception of the seat occupancy sensor and the steering wheel sensor, this may in particular be a mobile measuring device. These have an advantage in that the driver is also able to carry them along outside the vehicle without significant disruption, so that the acquisition of the first measurement values can take place largely without disturbance, even when occurring over a longer period of time. This can increase the driver's willingness to use the measuring devices. In particular, these measuring devices can be products that the driver would be taking with him even irrespective of the measurement, such as is the case with a mobile telephone, clothing, or eyeglasses or sunglasses, respectively comprising an integrated sensor.

According to a further preferred embodiment, the driver state detection comprises a driver diagnosis in which the question of which sensory channel or sensory channels would most effectively intervene with the driver is determined from at least one first measurement value. At least one of these determined sensory channels is then designated as a sensory channel of the driver that should in any event preferably be addressed in the driver intervention. In this manner, the at least one sensory channel needing to (preferably) be addressed can be efficiently determined with the same measuring devices that also are used in the subsequent driver state detection for the purpose of triggering a driver intervention, without necessitating any additional measuring devices for that purpose. In particular, this is possible in the event that the measuring devices are already a part of a vehicle system.

In addition, the at least one sensory channel needing to be addressed can be designated in this manner automatically and without forcing the driver's involvement. In a preferred aspect of this embodiment, a basic calibration for the driver state detection is carried out (preferably with a shorter duration, in the range of at most a few minutes, particularly at most one minute) before or immediately after the start of a ride, by way of an initial driver diagnosis. Then, during the following ride, this basic calibration can be further optimized using additional driver diagnoses, in order to achieve an even better adaptation to the respective driver.

In a further development of this embodiment, the driver diagnosis comprises detection of the reaction of the driver to various sensory stimuli, and in particular to various signals that can be generated as a part of the driver intervention. The detected reaction of the driver can then help in determining which sensory channel or sensory channels would most effectively intervene with the driver. In this manner, it is possible to systematically generate different sensory stimuli in order to act on the driver and achieve the correspond reactions, in order to have increased effectiveness and efficiency in identifying the at least one sensory channel needing to be addressed or a suitable combination of a plurality of sensory channels needing to be addressed, and in designating the same for use as a part of the driver intervention. In particular, the reaction of the driver to various sensory stimuli can be achieved with the aid of sensor-based acquisition of at least one of the following: one or more second measurement values characterizing a physical and/or psychological state of the driver; at least one driver action, in particular for vehicle control; and vehicle state data. Thus, it is also possible to reach a selection of the predetermined signal in accordance with handicaps of the driver, such as a hearing or vision impairment. In this manner, it is advantageously possible to avoid an ineffective driver intervention caused by a signal that is only poorly perceptible or even imperceptible to the driver.

According to a further preferred embodiment, the predetermination of the signal or the designation of the at least one sensory channel comprises a selection, on a user interface, of one or more signals or signal characteristics or of one or more sensory channels. In this manner, as an alternative or in additional to the previously described automatic designation of the at least one sensory channel needing to be addressed, it is also possible for the driver or another person to directly and, in particular, manually select the sensory channel or sensory channels needing to be addressed. Thus, it is also possible to forgo a preceding acquisition of measurement values for designating the at least one sensory channel that need to be addressed. The user interface may, in particular, be a switch, such as a knob, or may involve a more complex user interface, in particular a touch-sensitive screen (touch screen) or a combination of a display device and a mechanical input device.

According to a further preferred embodiment, the user profile data that identifies the driver and the associated at least one designated sensory channel is stored. The designation of the at least one sensory channel for the driver takes place then during a subsequent ride, by reading out the user profile data that has been stored for that driver. This embodiment can, in particular, be combined with the two previously described embodiments in which the at least one sensory channel needing to be addressed is selected automatically or via a user interface. Storing the user profile data, which can later be retrieved, makes it possible to advantageously omit a repeat designation of the at least one sensory channel needing to be addressed when the same driver drives later.

According to a further preferred embodiment, various predetermined signals are generated or altered as a part of the driver intervention in accordance with the first measurement value or combination of first measurement values for which there is determined to be a deviation from the respectively assigned predetermined target state or target state range. In this manner, it is possible to achieve a selective driver intervention in which the driver receives a targeted intervention in accordance with his respective physical or psychological state as detected in the driver state detection, so as to counteract the detected deviation through the respective signal and the corresponding reaction of the driver. It is thus possible to raise the effectiveness of the driver intervention as compared to solutions in which the signal is fixed irrespective of the type of deviation. On the one hand, the signal can lead the driver to draw conclusions about the type or magnitude of the deviation from the target state or target state range, and on the other hand, the signal will already have been selected so as to specifically counteract the deviation, instead of only non-specifically signaling a deviation (any deviation).

According to a further preferred embodiment, the predetermined signal is a combination of various individual signals, which address different sensory channels. The individual signals may then either be generated or altered substantially simultaneously, or may be prioritized relative to one another in accordance with the designation of the at least one sensory channel, and generated or altered in a staggered manner with respect to one another in a cascade, in particular according to the prioritization. In this manner, on the one hand, the variety of available signals is further increased by the addition of a combination signal, and on the other hand, so doing makes it possible to achieve a more targeted driver intervention than would be possible with the pure individual signals, such as only audio signals or only kinesthetically-acting signals.

According to a further preferred embodiment, if the driver is located in the vehicle, then the driver state detection takes place multiple times, in particular periodically or continuously, and the driver intervention takes place dynamically in response to the series of first measurement values acquired therein. In this manner, the driver intervention can be adapted during driving to a physical or psychological state of the driver that may possibly undergo changes during that time, so that a more effective driver intervention becomes possible. Thus, for example, in a case where the driver experiences increased stress while driving and this is detected by the driver state detection, then the driver intervention can be adapted in the course of the driving so as to act correspondingly to increasingly relieve the changing driver state, thus counteracting the driver's elevated stress and consequently counteracting the risk of an accident.

According to a further preferred embodiment, at least one first measurement value is also used to adjust user-defined vehicle settings. In particular, this can entail adjusting the vehicle interior, such as seat adjustment, mirror adjustment, volume adjustment of an audio system, arranging display or control elements on a configurable user interface (e.g., a touch screen), or adjusting an air conditioning function. In this manner, the operation of the relevant vehicle systems, in particular the interior systems, can be simplified or even omitted completely, because the adjustments are made automatically according to the driver's condition or state or according to his preferences. Thus, the comfort can be enhanced or the workload on the driver can also be reduced, which in turn can promote enhanced attentiveness and thus a decreasing risk of an accident.

According to a further preferred embodiment, the method includes the following additional steps: the driver state detection comprises reading out calendar data including appointments from an electronic calendar of the driver; the question of whether the appointment can be reached in time is determined by determining the travel time from the current location of the vehicle to an appointment location set forth in the calendar data; and if this not the case, then an electronic message is automatically sent to a predetermined circle of recipients, and in particular appointment participants who are set forth in the calendar data for the appointment, optionally after confirmation by the driver via a corresponding input on a user interface. The circle of recipients can then, in particular, also be only a single recipient, e.g., a team assistant, who is not himself or herself an appointment participant. In this manner, the driver can be relieved of a burden, and in particular it is possible to prevent the driver from being distracted from traffic and the operation of the vehicle in order to strive to, for example, manually place a phone call or compose and send an electronic message on his own in order to inform the appointment participants or even seek or coordinate a postponement of the appointment. This can also contribute to the objective driving safety, because if the driver knows that the system will automatically “take care of” the appointment that he is unable to reach on time, then it is possible to counteract the temptation to still try to reach the appointment by speeding, or at least to do so with a reduced delay. The calendar data can be accessed by a corresponding vehicle system, in particular, via an electronic interface or a radio interface to a mobile communication device of the driver and an electronic calendar located thereon, or a calendar of the driver that is available and accessible on the Internet via the mobile communication device.

According to a further preferred embodiment, a variety of degrees of the driver intervention can be selected by the driver, in particular via a user interface. In this manner, it is made possible for the driver to make an individualized choice regarding the assistance, and make various choices for different points-in-time. In particular, this even makes it possible to select a degree of the driver intervention at which assistance takes place largely only in the background. For instance, an automatic adjustment of various vehicle settings can be active, in particular before a ride or at the start of a ride, as can the previously described calendar function, while a driver intervention is taking place by way of signals only in exceptional cases, such as acutely dangerous situations. On the other hand, it would also be possible to select and thus activate a degree of the driver intervention at which a stronger driver intervention is used, in order to enhance the comfort and/or safety of the driver.

A second aspect of the invention relates to a system for personalized assistance for a driver of a vehicle, and in particular a motor vehicle. The system comprises: at least one interface for receiving measurement values from at least one sensor for acquiring at least one first measurement value, which characterizes a physical and/or psychological state of the driver; a comparison unit for comparing a first measurement value that can be received via the interface, or a combination of a plurality of such first measurement values, with a respectively assigned predetermined target state or target state range; and a signal device for a driver intervention, which is configured so as to generate or alter a predetermined signal if the comparison determines that there is a deviation of the first measurement value or the combination of first measurement values from the assigned predetermined target state or target state range. In addition, the system comprises: a designation unit by which it is possible to designate at least one sensory channel of the driver needing to be addressed in the driver intervention; and a signal determination unit which is configured in order to predetermine the signal so as to be in accordance with the determined deviation and so as to be suitable for addressing the at least one designated sensory channel.

The system may, in particular, be adapted to execute the previously described method according to the first aspect of the invention, and in particular according to one or more of the embodiments or developments thereof, or a combination thereof.

According to a further preferred embodiment of the system, the system can be equipped with a driver identification device for identifying the driver relative to the vehicle. In this manner, a user profile that was previously stored for a driver who was previously identified relative to the system can be accessed for that driver. Such a user profile may then already contain information about the preferences or needs of the driver, and in particular about the sensory channels that preferably need to be addressed as a part of the driver intervention with him. Thus, a repeated driver diagnosis or repeated adjustment of his user profile via a user interface or the like can be omitted. The identification here can take place by an assessment of measurement results of one or more of a variety of measurement devices. In particular, this can be one or more measuring devices, and in particular sensors, for acquiring the first measurement value, such as a camera which can be used for iris recognition. It would also be possible to employ a combination of a plurality of first measurement values acquired by a variety of sensors for the identification. There are other measuring devices, such as a fingerprint sensor, that can also be used. For the assessment, the measurement result or measurement results can be compared with one or more previously stored reference values, which are assigned to a particular driver, in order to determine, in the comparison, whether the driver is one of those already known to the system or which one the driver is.

A third aspect of the invention relates to a vehicle, and in particular a motor vehicle, comprising a system according to the second aspect of the invention. The vehicle may be, in particular, a passenger car, a truck (lorry), a bus, or a motorcycle.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system for personalized assistance for a driver of a vehicle according to a preferred embodiment of the invention;

FIG. 2 illustrates a flowchart for depicting a preferred embodiment of the method according to the invention;

FIG. 3 illustrates a flowchart for depicting a preferred development of the method according to the invention from FIG. 2; and

FIG. 4 illustrates a table showing possibilities of the driver state detection and the driver intervention, according to preferred embodiments of the invention.

### DETAILED DESCRIPTION OF THE DRAWINGS

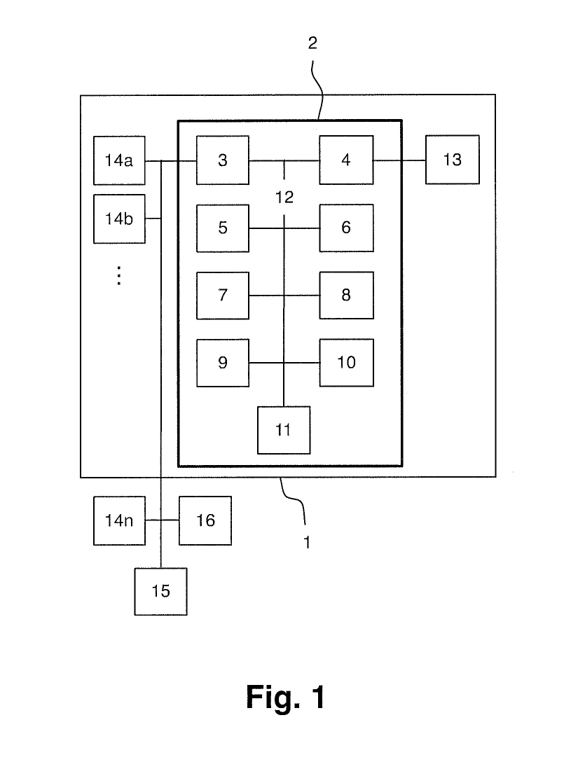

FIG. 1 schematically illustrates a system 2 for personalized assistance for a driver of a vehicle 1, and in particular a motor vehicle. The system includes a plurality of components 3 to 11, which are connected via a bus 12. Instead of a bus, it would also be possible to provide other network topologies, and in particular a star network emanating from a control device 4.

The system includes at least one interface 3 for receiving measurement values from at least one sensor 14a to 14n. This can, in particular, be a radio interface such as specified by the standardization organization 3GPP according to the known cellular standards (GSM, GPRS, EDGE, UMTS, LTE) or a short-range radio interface such as with Bluetooth, WLAN, NFC, or a WPAN interface (for example, according to IEEE 802.15.4). The sensor or sensors 14a to 14n serve to acquire at least one first measurement value, which characterizes a physical and/or psychological state of the driver. The sensors may, in particular, be configured in order to measure a temperature (in particular, the skin temperature), moisture (in particular, the air moisture or skin moisture), or body movements or accelerations from captured images of the driver (in particular, photographs or video) or from noises (in particular, speech or breathing sounds) originating from the driver, the driver's blood pressure or pulse rate, his pupil aperture, or his eye movements and gaze directions. The sensors 14a to 14n may then each be a part of the vehicle (sensors 14a and 14b in FIG. 1) or instead be independent of the vehicle, and in particular be mobile, so that the driver is able to carry them along when leaving the vehicle (sensor 14n in FIG. 1).

Accordingly, in addition to purely vehicle-integrated sensor arrays or purely mobile solutions, it is also possible to have mixed constellations in which one or more sensors belong to the vehicle and one or more other sensors are not themselves a part of the vehicle. In particular, it is possible to use sensors that are a part of a mobile terminal, such as a smart phone. Then, for example, the movement behavior of the driver can also be detected by means of suitable applications running on the terminal, over a longer period of time and/or outside the vehicle (such as via a health or sports application). This also includes the possibility of acquiring the driver's movements during sleep (such as via a sleep phase alarm clock application), in order to deduce in particular his fatigue therefrom.

Via the interface 3, the system is able to receive the measurement values acquired by at least one of the sensors 14a to 14n and assess the measurement values using a control device 4. The control device 4 may, in particular, contain a processor that can run software for assessing the measurement data and controlling additional system components, and in particular one or more of the components 5 to 11 (described below). Alternatively, a purely hardware-based solution is also able to provide comparable functionality. The functionality encompasses in particular a comparison of a first measurement value acquired through at least one of the sensors 14a to 14n, or a combination of a plurality of such first measurement values, with a correspondingly assigned predetermined target state or target state range. A target state here can be defined in particular as a normal value, and a target state range as a range around this normal value, or a range above or below the normal value which is then regarded as a threshold value.

Accordingly, the control device 4 includes at least a comparison unit for performing such a comparison, and in particular a comparison operation within a microprocessor. The target state or target state range can then in particular be specified in the form of data, entered into a memory 9, and made available to the control device 4 via the bus 12. The memory 9 may also be provided in order to store additional data and/or one or more computer programs for the control device. In addition, the control device 4 may control a signal device 5 for driver intervention, in accordance with the result of such a comparison. This signal device 5 is configured so as to generate or alter a predetermined signal if the comparison results in a deviation of the first measurement value or the combination of the plurality of first measurement values from the assigned predetermined target state or target state range.

In order to designate the predetermined signal, the system 2 further includes a designation unit 7. The designation unit is configured so as to make it possible to designate at least one sensory channel of the driver that needs to be addressed in the driver intervention. This designation can be made directly, in particular through a selection on a user interface 8 of the system. Alternatively or in addition, the designation can also be made in accordance with a driver diagnosis. This driver diagnosis can also be made, in particular, through the control device 4, and in particular on the basis of one or more of the first measurement values. Additionally or alternatively, a mobile driver diagnosis device 15 can also be used, which need not be a part of the vehicle, and can be connected, preferably via the interface 3, to the system 2 and, in particular, to the control device 4.

The system further includes a signal determination unit 6, which is configured in order to determine the signal so as to be dependent on a deviation established by the comparison unit of the control device 4, and so as to be suitable for addressing the at least one sensory channel of the driver as designated by the designation unit 7. Data that is generated in the driver diagnosis or that specifies the predetermined signal can also be entered into the memory 9.

The system also includes a driver identification device 10, by which a driver can be identified with respect to the vehicle 1 or the system 2. The driver identification device may in particular be a fingerprint sensor, or may be implemented on the user interface 8 in the form of a corresponding request, such as a code or password request or a driver selection.

In addition, a position determination device 11 may itself be a part of the vehicle 1, and in particular as is shown in FIG. 1, a part of the system 2. The position determination device 11, which in particular can be implemented through a navigation device or a navigation program, can be used, inter alia, in order to determine the position of the vehicle and, on the basis thereof, determine a remaining travel time T_{R} until a specified destination.

The specified destination can in particular be obtained from an entry in an electronic calendar 16, which either is available in the system 2 itself or instead is provided by an external device, and in particular by a mobile terminal. The position determination system 11 can alternatively be present in the external terminal. Such a mobile terminal may in particular be a mobile phone, a smartphone, a tablet computer, or a laptop computer. Additionally or alternatively, the electronic calendar may also be available on a server. These external data sources can be linked to the system 2, in particular each via the interface 3 or an alternative interface, or in particular via a radio interface.

Finally, the vehicle 1 may be equipped with one or more adjustable vehicle components 13 and, in particular, an air conditioning function, vehicle seats, or an entertainment system, which can each be controlled by the control device 4 and adjusted thereby. Appropriate adjustments to one or more vehicle components can then be deduced in accordance with the first measurement values or with a prior identification of the driver and an associated stored user profile, and a corresponding adjustment can be set forth by the control device 4.

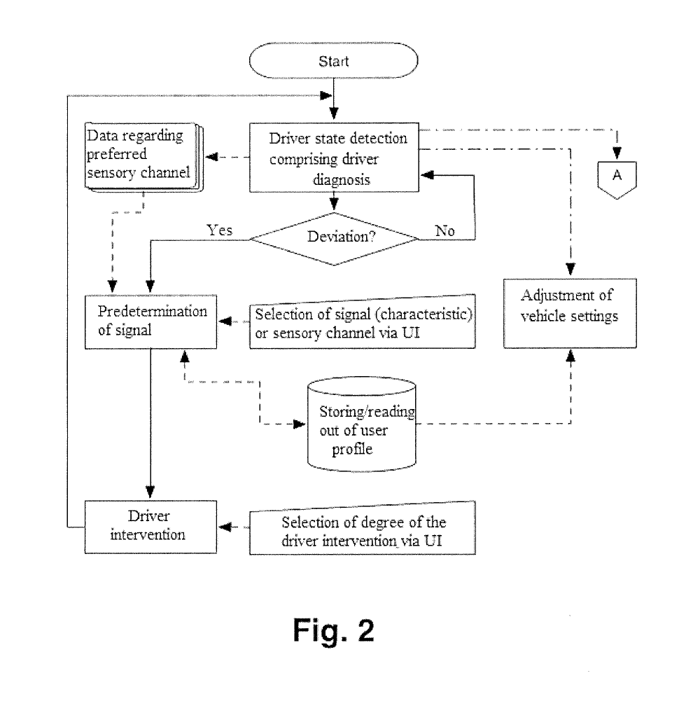

FIG. 2 depicts a preferred embodiment of a method according to the invention, in the form of a flowchart. The method can be embodied in particular on a system, as illustrated in FIG. 1. In the flowchart illustrated in FIG. 2, solid connecting lines depict the principal flow through the various steps of the method, the connections depicted with dotted lines correspond to data flows, and the connections depicted as dash-dotted lines illustrate side branches of the method, which can run in addition to the principal flow.

A first step in the method entails a driver state detection by way of sensor-based acquisition of at least one first measurement value characterizing a physical and/or psychological state of the driver. These measurement values can be acquired, in particular, via one or more of the sensors 14a to 14n (see FIG. 1). In one variant, the driver state detection can also include a driver diagnosis in which the question of which sensory channel or sensory channels would most effectively intervene with the driver is determined from the first measurement values. At least one of these determined sensory channels can then be designated as a sensory channel of the driver needing to be addressed in the driver intervention. In the driver diagnosis, a variety of signals can be generated, and the reaction of the driver to these signals or the sensory stimuli associated therewith can be detected, in order to thus select one or more of the sensory channels to which the driver exhibits an effective reaction of a desired type—i.e., a relaxation or enhanced attentiveness—for subsequent predetermination of a signal for the driver intervention. The information about these selected or preferred sensory channels is acquired in the form of corresponding data, and optionally stored temporarily in order for the information to then be used, even in a time-delayed manner, in the predetermining of the signal for the driver intervention.

A further step entails a comparison of the first measurement value acquired in the driver state detection, or a combination of a plurality of such first measurement values, with an assigned predetermined target state or target state range. In one variant, for example, the driver's skin moisture and his pulse can be detected as first measurement values via suitable sensors, and then respectively compared with an assigned value range that corresponds to a predefined target state range. Then, if at least one of the first measurement values lies outside the assigned target state range thereof, then, for example, a fatigue state or instead a strained state of the driver can be deduced depending on the direction of the deviation, so that a driver intervention is displayed. Additionally or alternatively, the acquired first measurement values can also be mathematically combined with one another, following which the result of this combination is compared with an assigned target state or target state range. If no deviation is established in this comparison step, then the method can preferably return back to the step of the driver state detection, so as to enable a dynamic, i.e., repeated or ongoing review of the driver state.

Otherwise, i.e., in the event of a deviation, the method proceeds to the next step, in which a signal needing to be output as a part of the driver intervention is predetermined. The signal is predetermined on the basis of the established deviation and of the question of which sensory channel or sensory channels of the driver was/were previously designated as the sensory channels needing to be addressed. This designation can be contained in the data previously generated during the driver diagnosis about one or more preferred sensory channels.

Alternatively or additionally, the designation can be performed by the driver himself, via an appropriate user interface (UI). Finally, the designation can also be taken from a previously-created user profile for the driver, which can be read out from a memory in which it was previously stored.

Finally, a further step entails the driver intervention, in which a predetermined signal is generated or altered. The predetermined signal has already been described previously. Alteration of the predetermined signal is here understood to mean that an already-existing signal is modified so that the action on the driver takes place through this alteration. In particular, for example, an already-running air conditioning can be set differently so that the driver at least unknowingly receives an intervention via, for example, an increase or decrease in the temperature. The same applies for alterations to acoustic signals that are already playing over an entertainment system.

In variants of the invention, the degree of the driver intervention can then be affected by the driver himself, in particular through a user interface. Thus for example, the extent of a temperature or volume change as a part of the driver intervention can be limited, in particular through a maximum or minimum value, which can be set via the user interface.

The method depicted in FIG. 2 also includes two other method branches (side branches), which can each run in addition to the principal method branch.

On the one hand, it is possible to use a first side branch of the first measurement value or measurement values, which is/are acquired as a part of the driver state detection, in order to carry out user-defined vehicle settings on the basis thereof. Thus, for instance, the air condition, the interior lighting, the entertainment system, other interior systems of the vehicle can be adjusted in accordance with the first measurement values, in a driver-specific manner. It is also possible to save the settings or at least one or more previously acquired first measurement values or a combination thereof as a part of the user profile of the driver, so that the adjustment of vehicle components can follow identification of the driver on the basis of his already-existing user profile.

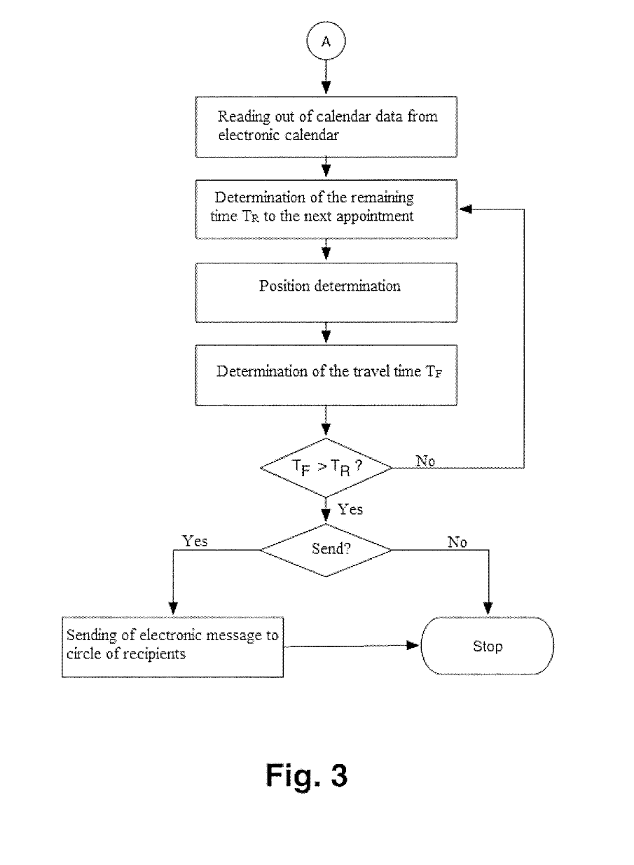

On the other hand, in a second side branch, the method may include the method part depicted in FIG. 3. This involves a method part in which, on the one hand, the driver's state can be deduced indirectly by extracting whether the driver is under time-related pressure due to an upcoming appointment, from his electronic calendar data. On the other hand, the driver can receive assistance with automatically informing a defined circle of recipients (in particular, other participants in the upcoming appointment), about a possible postponement. Thus, the psychological pressure on the driver can be reduced if a timely arrival at the appointment location is impossible, unlikely, or only possible at excessive speed and thus increased accident risk.

Specifically, this partial method may proceed as follows: first, one or more calendar entries are read out from an electronic calendar of the driver. The electronic calendar can be either available in the system or vehicle itself or instead can be accessible via a communication link, e.g., to a server, a mobile terminal, or a computer. From the calendar entries, a determination is then made as to when the next appointment for the driver is registered in the electronic calendar and at which location this appointment shall take place. In a next step, the remaining time T_{R} to this next appointment is calculated.

This is accompanied by a position determination, which can be provided in particular via a navigation system of the vehicle itself. Alternatively or additionally, it is also possible to use a vehicle-independent navigation system, such as a mobile navigation system or a mobile terminal having a navigation function, in order to carry out the position determination. The remaining travel time T_{F} to the appointment location is then calculated on the basis of the determined position and the appointment location extracted from the calendar.

The question of whether the appointment can still be reached in a timely manner is determined by making a comparison between the remaining travel time T_{F} and the remaining time T_{R} until the appointment. If this is the case, then the method returns to the step in which the time to the next appointment that still remains from that point-in-time is determined. It can also be provided that a renewed run only takes place after a time delay, in order to reduce the energy consumption for performing the method. If the comparison shows that the upcoming appointment probably can no longer be reached in time (TF>TR), then (optionally) the driver is asked to confirm whether an electronic message should be sent to the circle of recipients. If he agrees, then the electronic message is sent in order to inform the circle of recipients either that the appointment needs to be postponed or that the driver will arrive late. Otherwise, the partial method can be terminated, or can be continued for another appointment, in particular for the appointment that follows the first upcoming appointment.

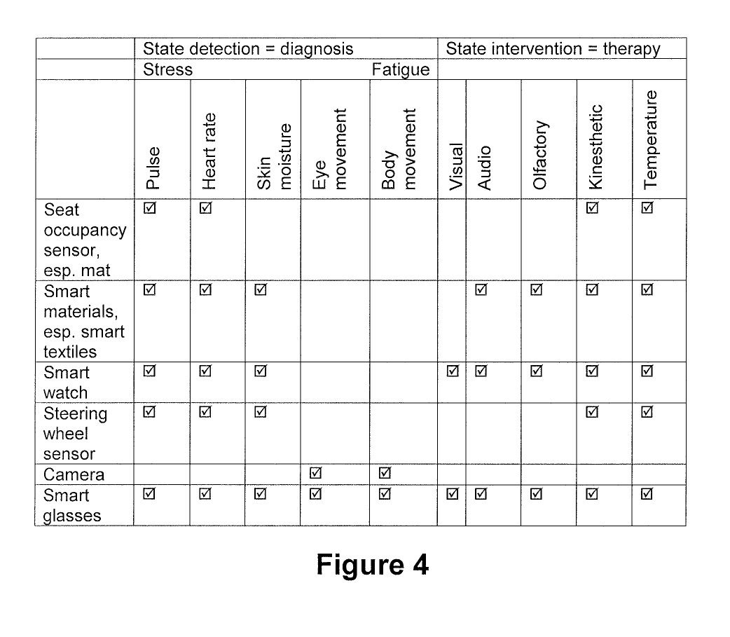

FIG. 4 illustrates a summarizing table representing a selection of preferred measuring devices for the driver state detection (in particular, for the driver diagnosis) and for the driver state intervention, each respectively alongside with the preferred application areas thereof. Thus, for instance, it is possible to use smart glasses in order to detect the state on the basis of the observation of the driver's eyes, and transmit visual, audio, or olfactory signals to him as part of a state intervention, i.e., the driver intervention. The possibilities depicted in the table for the state detection and state intervention constitute only a preferred selection, without excluding the possibility, through the corresponding measuring devices, of also acquiring others of the measured variables or signal types, or acquiring measured variables and outputting signal types not depicted in FIG. 4 which go beyond them. The additional information “stress” and “fatigue” are to be understood here such that the parameters that are arranged on the left side of the table and need to be consulted for the driver diagnosis can be particularly suitable for detecting stress, while the parameters arranged on the right side can be particularly suitable for detecting fatigue. However, this is not to be interpreted in a mutually exclusive sense.

For example, it would also be possible to consult the driver's pulse in order to detect fatigue or to consult his head movement in order to detect stress.

While previously at least one exemplary embodiment has been described, it should be noted that a vast number of variations also exists.

It should also be noted here that the described exemplary embodiments only represent non-limiting examples, and there is no intention of thereby limiting the extent, applicability, or configuration of the devices and methods described here. Rather, the foregoing description shall provide a person skilled in the art with guidance for implementing at least one exemplary embodiment, wherein it shall be understood that a variety of alterations in the function and arrangement of the elements described in the exemplary embodiment can be made without departing from the subject matters respectively set forth in the appended claims nor from the legal equivalents thereof.

### LIST OF REFERENCE SIGNS

1 Vehicle, in particular a motor vehicle;
2 System for personalized assistance for a driver;
3 Interface for one or more sensors
4 Control device comprising comparison means
5 Signal device for the driver intervention
6 Signal determination unit
7 Designation unit
8 User interface
9 Memory
10 Driver identification device
11 Position determination device
12 Bus
13 adjustable vehicle component(s)
14a-n Measuring means, in particular sensors
15 Mobile driver diagnosis device
16 Electronic calendar

Since modifications of the disclosed embodiments incorporating the spirit and substance of the invention may occur to persons skilled in the art, the invention should be construed to include everything within the scope of the appended claims and equivalents thereof.

What is claimed is:

1. A method for personalized assistance for a driver of a vehicle, the method comprising the acts of:
detecting a driver state via a sensor-based acquisition of at least one first measurement value characterizing a physical and/or psychological state of the driver;
comparing the acquired first measurement value, or a combination of a plurality of said first measurement values, with an assigned predetermined target state or target state range;
if the comparing act establishes that the first measurement value, or combination of first measurement values, deviates from the assigned predetermined target state of target state range, performing a driver intervention in which a predetermined signal is generated or altered, wherein
at least one sensory channel of the driver needing to be addressed in the driver intervention is designated in a driver-dependent manner, and
the predetermined signal is predetermined in accordance with the established deviation and so as to be suitable for addressing the at least one designated sensory channel.

2. The method according to claim 1, wherein the act of detecting the driver state is carried out while the driver is outside of the vehicle.

3. The method according to claim 1, wherein the sensor-based acquisition of the at least one first measurement value takes place by one or more of the following measuring devices:
a) a seat occupancy sensor;
b) a smart textile comprising a sensor;
c) a smart watch;
d) a steering wheel sensor;
e) a camera;
f) smart glasses comprising an eye-tracking function; and
g) a communication terminal comprising a sensor.

4. The method according to claim 1, wherein the act of detecting the driver state comprises a driver diagnosis in which a question of which sensory channel or sensory channels would most effectively intervene with the driver is determined from at least one first measurement value, and at least one of these determined sensory channels is designated as the sensory channel of the driver needing to be addressed.

5. The method according to claim 4, wherein:
the driver diagnosis comprises acquisition of a reaction of the driver to various sensory stimuli; and
the question of which sensory channel or sensory channels would most effectively intervene with the driver is determined with the aid of the measurement values and the acquired reaction of the driver.

6. The method according to claim 5, wherein the acquisition of the reaction of the driver to various sensory stimuli takes place with the aid of sensor-based acquisition of at least one of the following:
a) one or more measurement values characterizing a physical and/or psychological state of the driver;
b) at least one driver action for vehicle control; and
c) vehicle state data.

7. The method according to claim 1, wherein the predetermination of the signal or the designation of the at least one sensory channel comprises a selection, via a user interface, of one or more signals or signal characteristics or of one or more sensory channels.

8. The method according to claim 1, wherein:
user profile data that identifies the driver and the associated at least one designated sensory channel is stored, and
the designation of the at least one sensory channel for the driver takes place in a subsequent vehicle trip through reading out of the user profile data that has been stored for the driver.

9. The method according to claim 1, wherein:
the predetermined signal is a combination of different individual signals, which each address different sensory channels; and
wherein the individual signals either:
(a) are generated or altered at substantially the same time, or
(b) are prioritized relative to one another in accordance with the designation of the at least one sensory channel, and generated or altered in a staggered manner with respect to one another in a cascade according to the prioritization.

10. The method according to claim 1, wherein if the driver is located in the vehicle, then the driver state detection takes place multiple times, and the driver intervention takes place dynamically in response to the series of first measurement values acquired therein.

11. The method according to claim 1, wherein at least one first measurement value is also used to adjust user-defined vehicle settings.

12. The method according to claim 1, wherein:
the driver state detection comprises reading out calendar data including appointments from an electronic calendar of the driver;
a question of whether the appointment can be reached in time is determined by determining the travel time from the current location of the vehicle to an appointment location set forth in the calendar data; and
if the appointment cannot be reached in time, then an electronic message is automatically sent to a predetermined circle of recipients.

13. The method according to claim 12, wherein the predetermined circle of recipients comprise appointment participants identified in the calendar data for the appointment.

14. The method according to claim 12, wherein the automatic sending of the electronic message is carried out only after a confirmation by the driver via a user interface.

15. The method according to claim 1, wherein a variety of degrees of the driver intervention can be selected by the driver.

16. The method according to claim 1, wherein the vehicle is a motor vehicle.

17. A system for personalized assistance for a driver of a vehicle, the system comprising:
at least one interface for receiving measurement values from at least one sensor for acquiring at least one first measurement value that characterizes a physical and/or psychological state of the driver;
a comparison unit for comparing a first measurement value that is receivable via the interface, or a combination of a plurality of such first measurement values, with a respectively assigned predetermined target state or target state range; and
a signal device for a driver intervention, which is configured in order to generate or alter a predetermined signal if the comparison determines that there is a deviation of the first measurement value or the combination of first measurement values from the assigned predetermined target state or target state range;
the system further comprising:
a designation unit, by which at least one sensory channel of the driver needing to be addressed in the driver intervention is designated; and
a signal determination unit which is configured in order to predetermine the signal so as to be in accordance with the determined deviation and so as to be suitable for addressing the at least one designated sensory channel.

18. The system according to claim 17, wherein the vehicle is a motor vehicle.

19. A vehicle comprising the system according to claim 17.
